(19) United States
(12) Patent Application Publication
(10) Pub. No.: US 2008/0042801 A1
(43) Pub. Date: Feb. 21, 2008

(54) SYSTEM AND METHOD FOR PREVENTING UNAUTHORIZED USE OF AN AFTERMARKET REMOTE STARTER TO BYPASS AN OEM SECURITY SYSTEM

(75) Inventor: Robert A. Nelson, Hampstead (CA)

Correspondence Address: MERCHANT & GOULD PC, P.O. BOX 2903, MINNEAPOLIS, MN, 55402-0903, US

(73) Assignee: Automobility Distribution Inc., Ville St-Laurent (CA)

(21) Appl. No.: 11/780,948

(22) Filed: Jul. 20, 2007

Related U.S. Application Data
(63) Continuation-in-part of application No. 10/614,730, filed on Jul. 7, 2003.

(30) Foreign Application Priority Data
Jul. 5, 2002 (CA) 2,392,635

(51) Int. Cl. G08C 17/02

(52) U.S. Cl. 340/5.64

(57) ABSTRACT

A system for preventing the unauthorized by-pass of an OEM security system including an Original Equipment Manufacturer (OEM) starter for starting a vehicle, the vehicle having an engine and an ignition, an OEM security system responsive to an OEM security signal, an aftermarket by-pass kit for by-passing the OEM security system upon receipt of an aftermarket data signal which is distinct and separate from the OEM security signal, an aftermarket remote car starter device in communication with the by-pass kit for sending the aftermarket data signal to the by-pass kit to disable the OEM security system by causing the bypass kit to send the OEM security signal to the OEM security system and to start the engine, and a remote car starter transmitter in wireless communication with the remote car starter device. The communication between the by-pass kit and the remote car starter device is effected through a code-hopping mechanism; through encryption or through a unique code matching the by-pass kit to the remote car starter device.

This is a Continuation-in-Part of U.S. Ser. No. 10/614,730, filed on Jul. 7, 2003, and which application(s) are incorporated herein by reference.

### FIELD OF THE INVENTION

The present invention relates to a system and method for preventing the unauthorized use of an aftermarket remote starter to bypass an OEM vehicle security system, or engine, or starter disable.

### DESCRIPTION OF THE PRIOR ART

Remote car starters are well known in the art and generally comprise a portable RF transmitter borne by a person and a device in a vehicle, which upon receipt of an appropriate remote start signal emitted from the transmitter, allows the starter module to begin to start the vehicle.

Many vehicles are provided with original equipment manufacturer (OEM) security systems, starter disable systems or engine disable systems. These will be generically referred to in the present description as “OEM security systems”. Typically, such an OEM system is responsive to an OEM security signal comprising an OEM security code. This OEM security code is recorded in advance when the ignition is manufactured and used as a means of validating the identity of a user prior to engine start. The OEM security system prohibits starting of the engine until the OEM code is provided by the user.

In order for an aftermarket remote car starter to function properly, they must be provided with by-pass kits to by-pass the OEM security systems. Such by-pass kits are well known in the art, and are commercialized under vehicle-specific or generic kits. The by-pass kit is used in conjunction with a remote starter which is installed in the vehicle and operable to receive a remote start signal from the portable RF transmitter. In operation, the remote starter then sends an engine start signal to a security system by-pass kit, which in turn disables the OEM security by sending the OEM security signal thereto.

These by-pass kits are of two varieties. The first one is transponder-based. When a signal is received from the remote starter, the transponder sends a signal to the barrel of the ignition to start the engine. The second one is microprocessor-based, and upon receipt of a signal from the remote starter, the microprocessor sends a signal to the OEM security system to start the car. In fact, the signal that is sent is essentially grounding one of the wires.

These conventional aftermarket remote starter by-pass kits can be used to circumvent the OEM security system by thieves in order to steal the vehicle. In the case of the microprocessor-based by-pass, this is done by applying a ground signal to the by-pass kit in order to imitate the signal sent from the remote starter, and in the case of the transponder-based by-pass, by actually physically placing the by-pass transponder near the steering column of the vehicle and breaking the ignition.

For example, U.S. Pat. No. 5,612,578 issued Mar. 18, 1997 to Drew teaches an aftermarket remote starter for installation in a vehicle with an OEM security system. The OEM security system comprises an ignition key having an OEM security code in the form of a pre-selected electrical resistance. The OEM security system further comprises a resistance sensing start-enable unit, such as General Motor's Vehicle Anti-Theft System (VATS). The aftermarket remote starter includes a remote transmitter, a remote start/run controller which is coupled to a series of vehicle sensors, and a by-pass kit which is installed between the start-enable unit and the ignition switch for emulating the OEM security code. A drawback of this type of by-pass is that the signal sent imitating the remote starter is in fact a ground signal which can be created by an unauthorized individual in order to steal the vehicle.

### SUMMARY OF THE INVENTION

It is an object of the present invention to provide a system and method for preventing an unauthorized use of an aftermarket remote starter to bypass an OEM security system.

In accordance with one aspect of the invention there is provided a system for preventing the unauthorized by-pass of an OEM security system comprising:

an Original Equipment Manufacturer (OEM) starter for starting a vehicle, the vehicle having an engine and an ignition;

an OEM security system in communication with said starter and responsive to an OEM security signal;

an aftermarket by-pass kit for by-passing said OEM security system upon receipt of an aftermarket data signal which is distinct and separate from the OEM security signal and enabling remote car starting of said vehicle without placing a key in said ignition;

an aftermarket remote car starter device in communication with said by-pass kit for sending said aftermarket data signal to said by-pass kit to disable said OEM security system by causing said bypass kit to send said OEM security signal to said OEM security system and to start said engine; and

a remote car starter transmitter in wireless communication with said remote car starter device;

wherein communication between said by-pass kit and said remote car starter device is effected through a code-hopping mechanism; through encryption or through a unique code matching said by-pass kit to said remote car starter device.

Generally, the invention consists in improvements to a conventional aftermarket remote starter by-pass kit so that it by-passes the OEM security system only upon receipt and/or transmission of specific data. Simply applying a ground to the by-pass kit will not bypass the OEM security system as in the case of a conventional aftermarket remote starter. In the case of the transponder by-pass, the OEM transponder is encased in a metal box (through which the signal cannot go through), so that the OEM security system is by-passed only upon receipt and/or transmission of specific data. Alternatively, a transmitter can be installed in the car which transmits constantly to the OEM security system to keep it busy so that even if the proper key is received, as will be explained hereinafter

### BRIEF DESCRIPTION OF THE DRAWINGS

The present invention and its advantages will be more easily understood after reading the following non-restrictive description of preferred embodiments thereof, made with reference to the following drawings in which:

FIG. 1 is a schematic representation of the system according to a preferred embodiment of the invention;

FIG. 2 is a schematic representation of the system according to another preferred embodiment of the invention; and

FIG. 3 is a schematic representation of the system according to yet another preferred embodiment of the invention.

### DESCRIPTION OF PREFERRED EMBODIMENTS OF THE INVENTION

The present invention concerns a system and method for preventing unauthorized bypass of a remote car starter 15. Vehicles are nowadays equipped with an OEM security system 12, in communication with an OEM starter 11. When a vehicle is equipped with a remote car starter 15, a by-pass kit 13, 13′ must be provided to enable remote starting of the vehicle. The present invention concerns improvements to such by-pass kits 13, 13′ to increase security and to decrease the risk of theft of the vehicle.

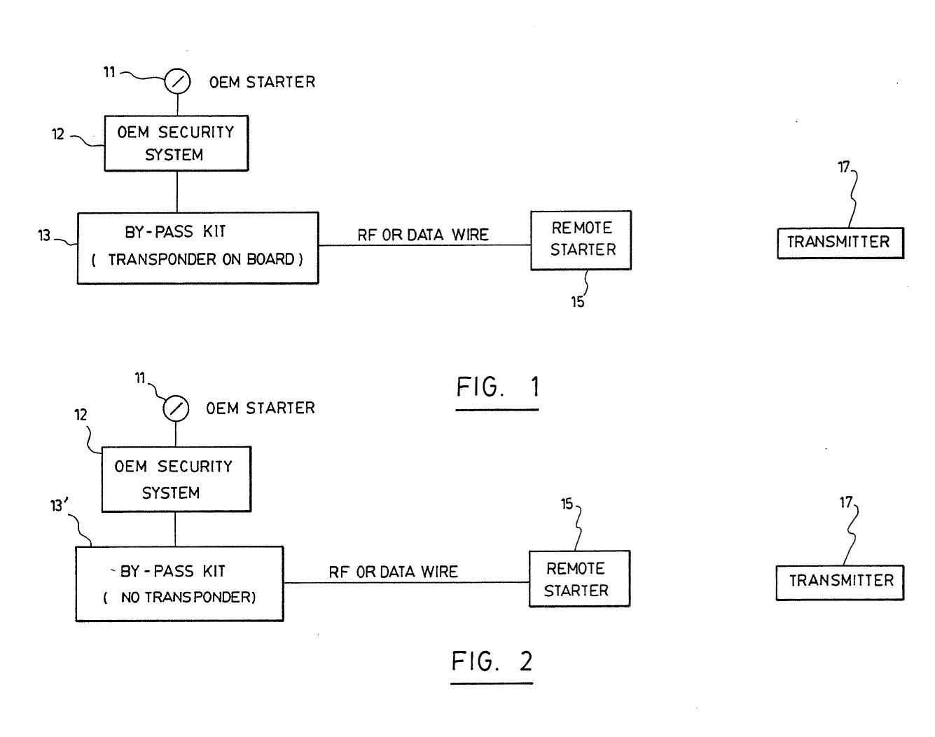

FIG. 1 is a schematic representation of the system according to a first preferred embodiment of the invention. This Figure shows an aftermarket bypass kit (transponder on board) 13 for bypassing the factory-installed OEM security system 12. As discussed above, the OEM security system 12 is in communication with the vehicle starter 11 and is responsive to an OEM security signal which has been recorded in advance when the security system is manufactured. The interconnection of the bypass 13 with the remote starter 15 can be through a data wire or cable, or RF, where the information that is transmitted is an aftermarket data signal which is distinct and separate from the OEM security signal. The communication of the aftermarket data signal between the bypass kit 13 and the remote car starter 15 is effected through a code-hopping mechanism, through encryption or through a unique code matching the by-pass kit 13 to the remote car starter 15. The communication although preferably unidirectional can also be bi-directional in order to increase the degree of security. The bypass kit 13 is encased in metal. The purpose of encasing the bypass kit 13 in metal is to prevent the transponder signal from exiting the bypass. If the bypass kit 13 were not encased in metal, thieves would still be able to locate the bypass kit 13, physically approach the steering column with it and start the engine, since the receiver aboard the vehicle would still read the correct signal. Hence, the bypass kit 13 is encased in metal, and the bypass will be activated only if the correct data is sent. Thus, when activating the transmitter 17 to remotely start the car, the remote starter 15 sends an aftermarket data signal to the by-pass kit 13 and the by-pass kit 13 sends the OEM security signal to the OEM security system 12 disabling it and thereby enabling starting of the vehicle.

FIG. 2 is a schematic representation of the system according to a second preferred embodiment of the invention. In this case, the aftermarket bypass kit 13′ is micro-processor based, and the vehicle is, as is standard, equipped with an OEM security system 12. This OEM security system 12 is in communication with the aftermarket bypass 13′, which does not have a transponder, and is responsive to an OEM security signal. The bypass kit 13′ is then in communication with the remote starter 15. Again, the information that is exchanged between the bypass kit 13′ and the remote starter 15 is an aftermarket data signal, rather than the conventional ground signal, which helps prevent unauthorized bypass of the aftermarket remote starter 15. Also, the communication could be unidirectional or bidirectional for added security. The communication of the aftermarket data signal between the bypass kit 13′ and the remote car starter 15 is effected through a code-hopping mechanism, through encryption or through a unique code matching the by-pass kit 13′ to the remote car starter 15.

As mentioned previously, the advantages of the present invention lie in the improvements to the by-pass kit 13 or 13′ to adapt it to remotely start the vehicle only upon receipt of an aftermarket data signal. Thus, applying a ground to the conventional microprocessor based by-pass or physically placing the transponder near the steering column will no longer permit thieves to steal the vehicle.

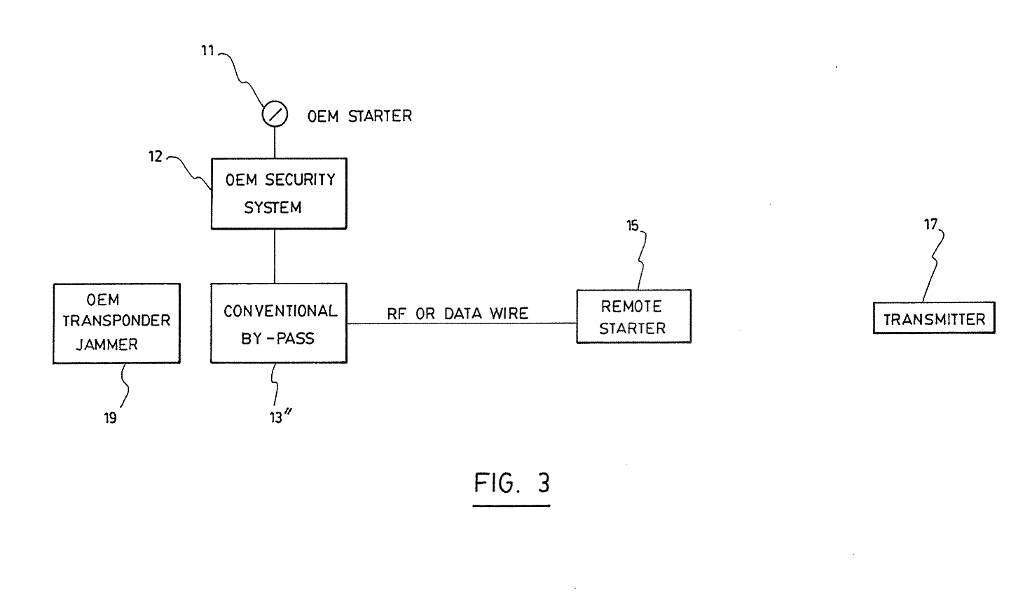

FIG. 3 is a schematic representation of yet another embodiment of the invention including a conventional by-pass kit 13″. There, an OEM transponder jammer 19 is provided, which continuously jams the OEM security system which is in listen mode, listening for a correct code to be received in order to start the car. In order to start the vehicle, the OEM transponder jammer must be disabled. To that effect, the transmitter 17 is adapted to send a signal to the OEM transponder jammer to disable it at the same time the remote starter is enabled. Thus, when the OEM transponder jammer is enabled, even having the right key in the ignition will not start the vehicle. It should be noted that this third embodiment can also be adapted to be used as an added security layer. In fact, for cars that are equipped with transponders, it is possible to have authorized persons, such as employees of a garage, program a second key into the vehicle, to enable these persons to start the vehicle. Thieves have been known to be in collusion with some garages, and use the newly programmed keys to steal the vehicle. Consequently, by having an OEM transponder jammer, the vehicle can only be started by the person having the transmitter to enable and disable the OEM transponder jammer.

In an advantageous embodiment, in the case where the vehicle is provided with an aftermarket security system, including a tracking device, the OEM transponder jammer can further be adapted to send a signal to an on-board chip which stores vital information such as the logical keys of the vehicle to erase them or burn the chip, thereby preventing further breaches of security.

In a preferred embodiment, the by-pass kit is adapted to “learn” the unique code associated with the remote starter, following technology which is readily available or communication between the remote starter and the by-pass kit can follow code-hopping techniques. In a further preferred embodiment, the code is encrypted following available techniques.

Although the present invention has been explained hereinabove by way of a preferred embodiment thereof, it should be pointed out that any modifications to this preferred embodiment within the scope of the appended claims is not deemed to alter or change the nature and scope of the present invention.

1. A system for preventing the unauthorized by-pass of an OEM security system, comprising:
an Original Equipment Manufacturer (OEM) starter for starting a vehicle, the vehicle having an engine and an ignition;
an OEM security system in communication with said starter and responsive to an OEM security signal;
an aftermarket by-pass kit for by-passing said OEM security system upon receipt of an aftermarket data signal which is distinct and separate from the OEM security signal and enabling remote car starting of said vehicle without placing a key in said ignition;
an aftermarket remote car starter device in communication with said by-pass kit for sending said aftermarket data signal to said by-pass kit to disable said OEM security system by causing said bypass kit to send said OEM security signal to said OEM security system and to start said engine; and
a remote car starter transmitter in wireless communication with said remote car starter device;
wherein communication between said by-pass kit and said remote car starter device is effected through a code-hopping mechanism; through encryption or through a unique code matching said by-pass kit to said remote car starter device.

2. A system according to claim 1, wherein said remote car starter is in wireless communication with said by-pass kit.

3. A system according to claim 1, wherein said remote car starter is in communication with said by-pass kit through a cable.

4. A system according to claim 1, wherein said by-pass kit includes a transponder on board and is encased in metal.

5. A system according to claim 1, wherein said by-pass kit has unique identifier, and wherein matching said by-pass unit to said remote starter comprises teaching said remote starter said unique identifier.
